(19) United States
(12) Patent Application Publication
(10) Pub. No.: US 2012/0216129 A1
(43) Pub. Date: Aug. 23, 2012

(54) METHOD AND APPARATUS FOR PROVIDING AN IMMERSIVE MEETING EXPERIENCE FOR REMOTE MEETING PARTICIPANTS

(76) Inventors: Hock M. Ng, Westfield, NJ (US); Edward L. Sutter, Fanwood, NJ (US); Richard M. Abbot, Belle Mead, NJ (US)

(21) Appl. No.: 13/029,168

(22) Filed: Feb. 17, 2011

(51) Int. Cl. G06F 3/01; G06F 15/16

(52) U.S. Cl. 715/753

(57) ABSTRACT

An immersive meeting capability is depicted and described herein. The immersive meeting capability is configured for improving various aspects of a meeting held between one or more local participants located at a physical location at which the meeting is being held and one or more remote participants remote from the physical location at which the meeting is being held. The immersive meeting capability enables the remote participants to access and/or control one or more devices located at the physical location at which the meeting is being held and/or one or more views associated with the physical location at which the meeting is being held, thereby enabling remote participants to become immersed into the meeting.

### FIELD OF THE INVENTION

The invention relates generally to communication networks and, more specifically but not exclusively, to facilitating a meeting including remote meeting participants.

### BACKGROUND

The growing trend of a geographically distributed workforce is driving a need for use of technology to facilitate remote collaboration between people. The existing tools that facilitate remote collaboration between people are lacking in terms of their ease of use and effectiveness. For example, in a typical meeting scenario, the common tools that are used include an audio conference bridge or a video connection together with Microsoft NetMeeting for content sharing. Disadvantageously, while this solution may be sufficient for sharing content, the remote users often feel disengaged from the meeting, because the remote users have only limited control of their own perspective of the meeting and/or what they are able to contribute to the meeting.

### SUMMARY

Various deficiencies in the prior art are addressed by embodiments of an immersive meeting capability configured for enabling a remote participant of a meeting to access and/or control various devices located at and/or views associated with a physical location at which the meeting is being held, thereby enabling the remote participants to become immersed into the meeting in a manner similar to local participants physically present at the physical location at which the meeting is being held.

In one embodiment, an apparatus includes a processor and a memory configured to: present, at a user device, a representation of a physical area configured for use in hosting a meeting, wherein the physical area includes a device configured for being accessed remotely, wherein the representation of the physical area includes a representation of the device or a representation of a view available from the device; detect, at the user device, selection of an icon associated with the representation of the device or the representation of a view available from the device; and propagate, from the user device, a message configured for requesting access to the device or the view available from the device.

In one embodiment, a method includes using a processor for: presenting, at a user device, a representation of a physical area configured for use in hosting a meeting, wherein the physical area includes a device configured for being accessed remotely, wherein the representation of the physical area includes a representation of the device or a representation of a view available from the device; detecting, at the user device, selection of an icon associated with the representation of the device or the representation of a view available from the device; and propagating, from the user device, a message configured for requesting access to the device or the view available from the device.

In one embodiment, an apparatus includes a processor and a memory configured to: obtain a representation of a physical area configured for use in hosting a meeting, wherein the physical area includes a device configured for being accessed remotely; create an area configuration for the physical area, wherein creating the area configuration comprises associating an icon with a representation of the device or a representation of a view available from the device; and propagate the area configuration toward a user device of a remote participant of a meeting held in the physical area.

In one embodiment, a method includes using a processor for: obtaining a representation of a physical area configured for use in hosting a meeting, wherein the physical area includes a device configured for being accessed remotely; creating an area configuration for the physical area, wherein creating the area configuration comprises associating an icon with a representation of the device or a representation of a view available from the device; and propagating the area configuration toward a user device of a remote participant of a meeting held in the physical area.

### BRIEF DESCRIPTION OF THE DRAWINGS

The teachings herein can be readily understood by considering the following detailed description in conjunction with the accompanying drawings, in which:

FIG. 1 depicts an exemplary system illustrating a room information manager (RIM) configured for enabling remote participants of a meeting to access and/or control devices located within the room in which the meeting is being held;

FIG. 2 depicts a high-level block diagram of one embodiment of the RIM of FIG. 1;

FIGS. 3A-3G depict exemplary GUI screens provided by the RIM of FIG. 1, illustrating use of manual interactions by a user with a representation of a room of for creating a room configuration for the room;

FIG. 4 depicts the exemplary system of FIG. 1, illustrating use of configuration capabilities of the devices located within the room in which the meeting is being held for creating a room configuration for the room;

FIG. 5 depicts one embodiment of a method for creating a room configuration for a room using room configuration information;

FIGS. 6A-6B depict exemplary GUI screens provided by the RIM of FIG. 1, illustrating use of a room configuration by a remote participant for accessing and controlling devices physically located within the room;

FIG. 7 depicts one embodiment of a method for using a room configuration of a room for accessing and controlling one or more devices physically located within the room;

FIG. 8 depicts one embodiment of an immersive room suitable for use as the room depicted and described with respect to FIG. 1; and

FIG. 9 depicts a high-level block diagram of a computer suitable for use in performing the functions described herein.

To facilitate understanding, identical reference numerals have been used, where possible, to designate identical elements that are common to the figures.

### DETAILED DESCRIPTION OF ILLUSTRATIVE EMBODIMENTS

An immersive meeting capability is depicted and described herein. The immersive meeting capability enables remote participants, in a meeting being held at a physical location, to access and/or control one or more devices located at the physical location at which the meeting is being held and/or one or more views associated with the physical location at which the meeting is being held, thereby enabling the remote participants to become immersed into the meeting and, thus, to become more productive. For example, devices may include video conference devices, audio conferencing devices, sensors, and the like, as well as various combinations thereof. For example, views may include a view available from a device located at the physical location (e.g., a view of a whiteboard available from a camera located at the physical location, a view of a podium available from a camera located at the physical location, and the like), a view available from a combination of multiple devices located at the physical location, a view associated with the physical location that is independent of any particular device located at the physical location, and the like, as well as various combinations thereof. It will be appreciated that various other devices and/or views may be supported.

Although primarily depicted and described herein with respect to use of the immersive meeting capability for remotely accessing and controlling specific types of devices and/or views in a specific type of room, it will be appreciated that the immersive meeting capability may be used for (1) remotely accessing and controlling various other types of devices and/or views, and/or (2) remotely accessing and controlling devices in various other types of rooms or locations.

Although the immersive meeting capability enables remote participants to access and/or control one or more devices and/or one or more views, the immersive meeting capability (for purposes of clarity in describing the various embodiments of the immersive meeting capability) is primarily depicted and described herein with respect to enabling remote participants to access and/or control one or more devices.

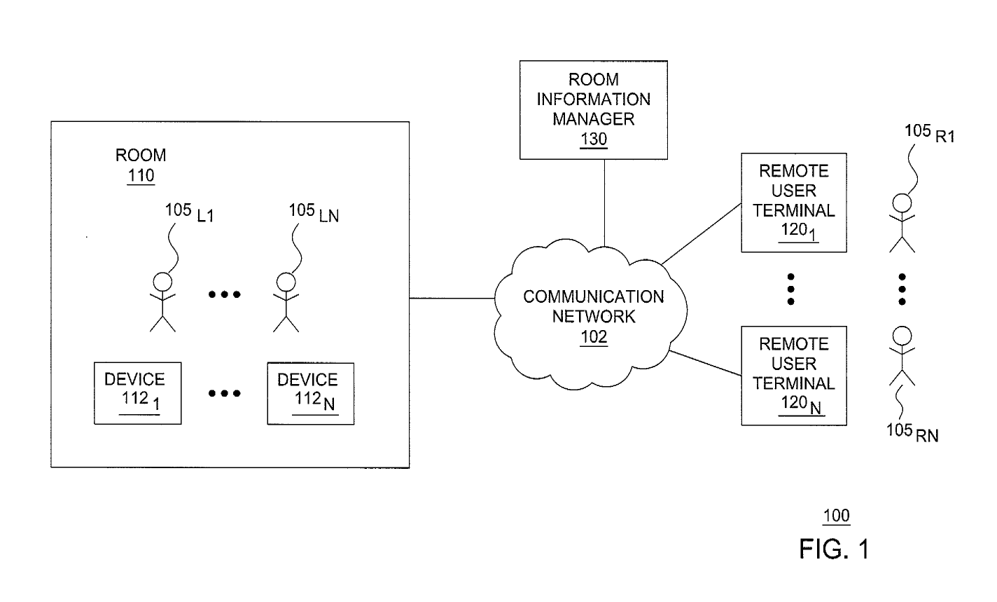

FIG. 1 depicts an exemplary system illustrating a room information manager (RIM) configured for enabling remote participants of a meeting to access and/or control devices located within the room in which the meeting is being held.

The exemplary system 100 includes a room 110 having a plurality of devices 112₁-112_{N} (collectively, devices 112) located therein, a plurality of remote user terminals 120₁-120_{N} (collectively, remote user terminals 120), and a room information manager (RIM) 130.

The exemplary system 100 includes a communication network 102 configured to provide communications among various components of exemplary system 100. The communications among various components of exemplary system may be provided using any suitable communications capabilities (e.g., Internet Protocol (IP), proprietary communications protocols and capabilities, and the like, as well as various combinations thereof).

The exemplary system 100 facilitates a meeting between (1) a plurality of local participants 105_{L1}-105_{LN} (collectively, local participants 105_{L}) located within the room 110 and (2) a plurality of remote participants (105_{R1}-105_{RN} (collectively, remote participants 105_{R}) associated with remote user terminals 120₁-120_{N}, respectively. Although primarily depicted and described herein with respect to a plurality of local participants 105_{L} and a plurality of remote participants 105_{R}, it will be appreciated that there may be one or more local participants 105_{L} and/or one or more remote participants 105_{R} for a meeting in which the immersive meeting capability is used. Although primarily depicted and described herein with respect to a one-to-one relationship between remote participants 105_{R} and remote user terminals 120, it will be appreciated that multiple remote participants 105_{R} may access a meeting via common remote user terminal 120.

The room 110 may be a conference room or any other type of room in which a meeting may be held.

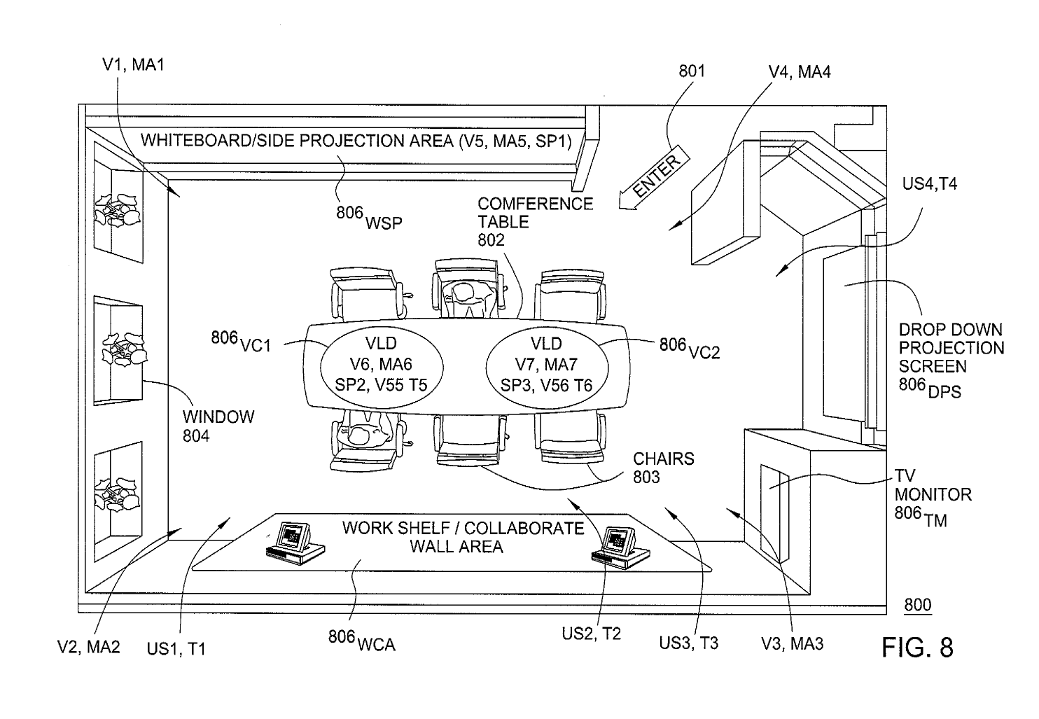

In one embodiment, room 110 is an immersive room. In general, an immersive room is a room configured with one or more content devices and a number of sensors, and which may include significant local computing power. An exemplary embodiment of an immersive room suitable for use with the immersive meeting capability is depicted and described herein with respect to FIG. 8.

Although depicted and described within the context of embodiments in which the meeting is held within a room, it will be appreciated that meetings may be held in areas other than a room (e.g., such as in common areas and the like). Thus, references herein to rooms may be read more generally as references to any suitable areas in which meetings may be held (which may be referred to herein as physical areas). The devices 112 include any devices which may be associated with a meeting being held in room 110, which may include devices that are unrelated to collaboration between participants of the meeting and/or devices that are related to collaboration between participants of the meeting. For example, devices unrelated to collaboration between participants of the meeting may include devices such as lighting controls, thermostat controls, and the like. For example, devices related to collaboration between participants of the meeting may include any suitable devices, such as an audio conferencing device for supporting an audio conference between participants of the meeting, a video conferencing device for supporting a video conference between participants of the meeting, one or more cameras providing views of room 110 in which the meeting is taking place, a projector projecting content for the meeting, a collaborative whiteboard capable of providing real-time interactive writing and drawing functions, a video conferencing device configured for providing face-to-face interactions between local participants 105_{L} and remote participants 105_{R}, and the like, as well as various combinations thereof.

The remote user terminals 120 used by remote participants 105_{R} may include any user devices configured for enabling remote participants 105_{R} to perform various functions associated with the immersive meeting capability. For example, remote user terminals 120 may include user devices configured for enabling remote participants 105_{R} to participate in the meeting being held in room 110. For example, remote user terminals 120 may include user devices configured for enabling remote participants 105_{R} to access RIM 130 for performing various configuration functions which may be performed before the meeting being held in room 110 (e.g., enabling remote participants 105_{R} to create a room configuration for room 110 which will be accessed and used by the remote participant 105_{R} during the meeting to access and/or control device 112 of room 110, enabling remote participants 105_{R} to personalize a room configuration for room 110 which will be accessed and used by the remote participant 105_{R} during the meeting to access and/or control device 112 of room 110, and the like). For example, remote user terminals 120 may include user devices configured for enabling remote participants 105_{R} to access RIM 130 at the time of the meeting for enabling remote participants 105_{R} to access a room configuration associated with the room 110 (e.g., a room configuration for room 110 which will be accessed and used by the remote participant 105_{R} during the meeting to access and/or control device 112 of room 110). For example, remote user terminals 120 may include user devices configured for enabling remote participants 105_{R} to access and/or control devices 112 of room 110. For example, remote user terminals 120 may include desktop computers, laptop computers, smartphones, tablet computers and the like. It will be appreciated that such remote user terminals 120 may support various types of user control capabilities (e.g., Graphical User Interface (GUI)-based controls, touch screen controls, voice-based controls, movement/gesture-based controls, and the like, as well as various combinations thereof) and presentation capabilities (e.g., display screens, speakers, and the like, as various combinations thereof) via which the remote participant 105_{R} may access and/or control devices 112 and/or views available from devices 112 for becoming immersed within and/or interacting with the meeting.

Although primarily depicted and described herein with respect to an embodiment in which a single remote user terminal 120 is used by a remote participant 105_{R}, it will be appreciated that each remote participant 105_{R} may use one or more user devices for performing various functions associated with the immersive meeting capability. For example, a remote participant 105_{R} may use a phone for listening to audio of the meeting, a computer for accessing and controlling devices 112 (e.g., projectors, cameras, and the like), and the like, as well as various combinations thereof.

As described herein, exemplary system 100 facilitates a meeting between local participants 105_{L} who are located within the room 110 and remote participants 105_{R} who may be located anywhere remote from the room 110.

The RIM 130 is configured for providing various functions of the immersive meeting capability, thereby enabling facilitation of meetings between local participants and remote participants, such as local participants 105_{L} and remote participants 105_{R} depicted and described with respect to FIG. 1.

The RIM 130 provides a configuration capability for enabling creation of room configurations for rooms in which meetings may be held, where a room configuration for a room may be accessed by remote participants to access and/or control devices of the room during the meeting.

In general, at some time prior to meetings being held in the room 110, a room configuration is created for the room 110. In general, a room configuration for a room provides a representation of the room, including representations of the devices 112 within the room 110, such that remote participants 105_{R} may access the room configuration during the meeting in the room 110 for accessing and/or controlling one or more devices 112 of room 110 during the meeting. The room configuration for room 110 may be created in any suitable manner (e.g., based on manual interaction by a user with a representation of the room, automatically based on interaction by devices 112 with each other and/or with one or more configuration devices, and the like, as well as various combinations thereof).

In one embodiment, for example, when the room configuration for room 110 is created based on manual interaction by a user with a representation of the room 110, RIM 130 provides a GUI via which the user enters selections that are processed for creating the room configuration of the room 110 and processing logic configured for processing the user selections for creating the room configuration of the room 110. In this embodiment, the user which creates the room configuration may be any suitable person (e.g., a person responsible for control of room 110 (e.g., a site administrator of a building in which room 110 is located), a chair or invitee of the meeting, and the like).

In one embodiment, for example, where the room configuration for room 110 is created automatically based on interaction by devices 112, RIM 130 includes processing logic configured for processing interaction information, associated with interaction performed by devices 112, for creating the room configuration of the room 110. In this embodiment, one or more of the devices 112 may interact with RIM 130 directly, the devices 112 may interact with each other and then provide the relevant interaction information to RIM 130 and/or to one or more other control devices configured for providing the interaction information to RIM 130, and the like, as well as various combinations thereof. The interaction by devices 112 may be provided using any suitable devices and/or technologies (e.g., cellular, WiFi, Bluetooth, infrared, sensors, and the like, as well as various combinations thereof). The interaction information for a device 112 may include information such as a device identifier of the device 112, a device type of the device 112, a location of the device 112 (e.g., within the context of the room 110, relative to other devices 112, and the like), device configuration information indicative of configuration of the device 112, and the like, as well as various combinations thereof. In one embodiment, automated location determination functionality (e.g., Radio-Frequency Identification (RFID)-based location determination, Global Positioning System (GPS)-based location determination, and the like) may be used during automatic creation of the room configuration for automatically determining locations of the devices 112 within the room 110 and, thus, within the associated room configuration of room 110. In one embodiment, RIM 130 includes or has access to a database of device types including information for different device types, thereby enabling RIM 130 to obtain various types of information about devices 112 as the devices 112 are identified from the associated interaction information. In one embodiment, RIM 130 includes or has access to a database of templates (e.g., including one or more of room configuration templates, device configuration templates, and the like) which may be used in conjunction with interaction information for enabling automatic creation of the room configuration for the room 110.

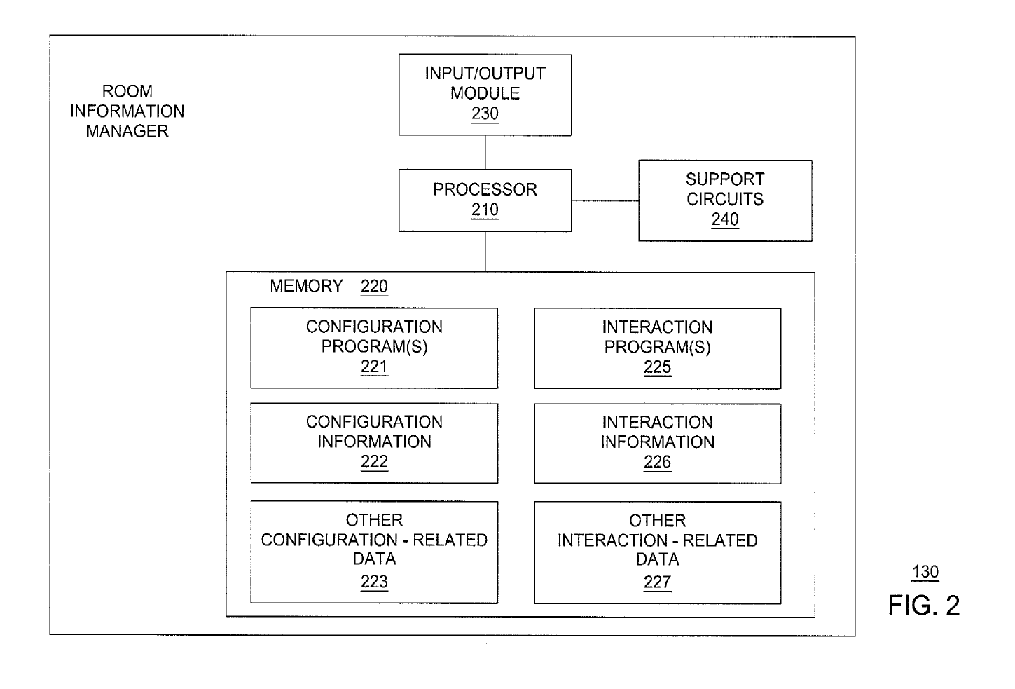

The configuration capability provided by RIM 130 may be better understood by way of reference to FIGS. 2, 3A-3G, and 4.

The RIM 130 provides an interaction capability for enabling remote participants of a meeting being held in a room to obtain a perspective of a meeting taking place in the room 110.

In general, at the time of the meeting, local participants 105_{L} and remote participants 105_{R} access the room 110 for purposes of participating in the meeting.

The local participants 105_{L} physically arrive at the room 110 and participate in the meeting locally, such that they may physically control the various devices 112 located within the room 110.

The remote participants 105_{R} access the room configuration for the room 110 in which the meeting is being held, and use the room configuration to obtain a perspective of the meeting taking place in room 110, even though they may be physically located anywhere around the world. The remote participants 105_{R} also may use the room configuration to remotely access and control devices 112 located within the room 110, such that remote participants 105_{R} are able to create their own personal perspectives of the meeting taking place in room 110.

In one embodiment, RIM 130 provides a GUI via which each of the remote participants 105_{R} may access a perspective of the meeting taking place in room 110, including accessing and/or controlling devices 112 located within the room 110. In this manner, remote participants 105_{R} are immersed within the meeting as if physically located within room 110.

In one embodiment, RIM 130 facilitates communications between the devices 112 within room 110 and remote user terminals 120 when the remote user terminals 120 are used by remote participants 105_{R} to access and/or control the devices 112 within room 110. The RIM 130 may facilitate such communications using any suitable communications capabilities (e.g., interfaces, protocols, and the like, as well as various combinations thereof). In this manner, each of the devices 112 may be connected to any number of other devices (e.g., remote user terminals 120, other devices, and the like), remote from room 110, which may communicate with the devices 112 for purposes of accessing and/or controlling the devices 112.

The interaction capability provided by RIM 130 may be better understood by way of reference to FIGS. 2, 5A-5C, and 6.

An exemplary RIM 130 is depicted and described with respect to FIG. 2.

FIG. 2 depicts a high-level block diagram of one embodiment of the RIM of FIG. 1. As depicted in FIG. 2, RIM 130 includes a processor 210, a memory 220, an input/output (I/O) module 230, and support circuits 240.

The processor 210 cooperates with memory 220, I/O module 230, and support circuits 240 for providing various functions of the immersive meeting capability.

The memory 220 stores configuration information associated with configuration functions provided by RIM 130, interaction information associated with interaction functions provided by RIM 130, and the like. For example, memory 220 stores one or more configuration programs 221 (e.g., for providing the GUI which may be used for generating room configurations), configuration information 222 (e.g., perspective view templates, perspective views, room configurations, and the like, as well as various combinations thereof), and other configuration information 223. For example, memory 220 stores one or more interaction programs 225 e.g., for providing the GUI(s) which may be used for enabling remote participants to access and/or control devices of rooms), interaction information 226 (e.g., room configurations for use in accessing and/or controlling devices of rooms, information associated with interaction by remote participants with devices of rooms, and the like, as well as various combinations thereof), and other interaction information 227.

The I/O module 230 supports communications by RIM 130 with various other components of exemplary system 100 (e.g., devices 112, remote user terminals 120, and the like).

The support circuits 240 may include any circuits or elements which may be utilized in conjunction with the processor 210, the memory 220, and the I/O module 230 for providing various functions of the immersive meeting capability.

Although primarily depicted and described herein with respect to specific components, it will be appreciated that RIM 130 may be implemented in any other manner suitable for providing the immersive meeting capability.

Although primarily depicted and described herein with respect to embodiments in which RIM 130 is implemented as a single physical device, it will be appreciated that the various functions of RIM 130 may be distributed across multiple devices which may be located in any suitable location(s).

Although primarily depicted and described herein with respect to use of RIM 130 to manage configuration and use of a room configuration for a single room, RIM 130 may be used to manage configuration and use of room configurations for any suitable number of rooms associated with any suitable number of geographic locations. In one embodiment, for example, one or more RIMs 130 may be used for providing the immersive meeting capability for rooms of a single building. In one embodiment, for example, one or more RIMs 130 may be used for providing the immersive meeting capability for rooms of multiple buildings (e.g., geographically proximate buildings which may or may not be administratively associated with each other, geographically remote buildings which may or may not be administratively associated with each other, and the like, as well as various combinations thereof. For example, one or more RIMs 130 may be used by a corporation, a university, or any other organization having one or more buildings which may be geographically proximate and/or remote.

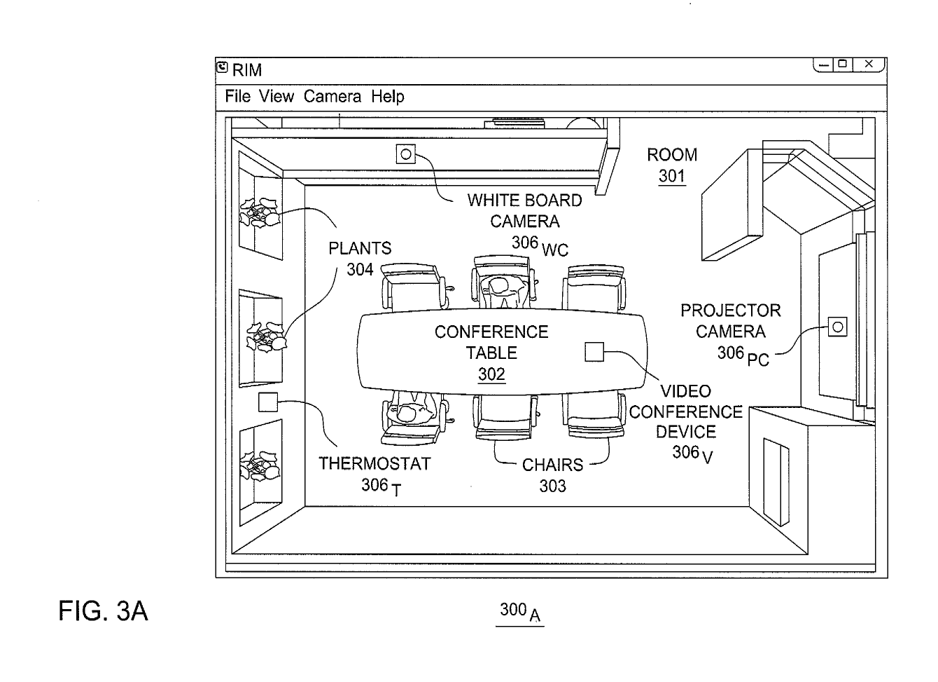

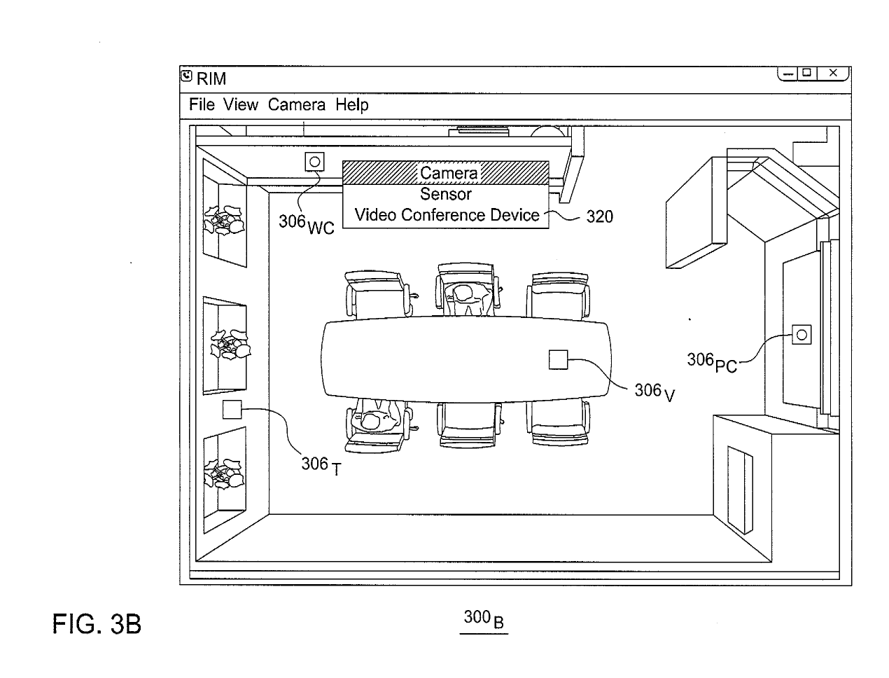

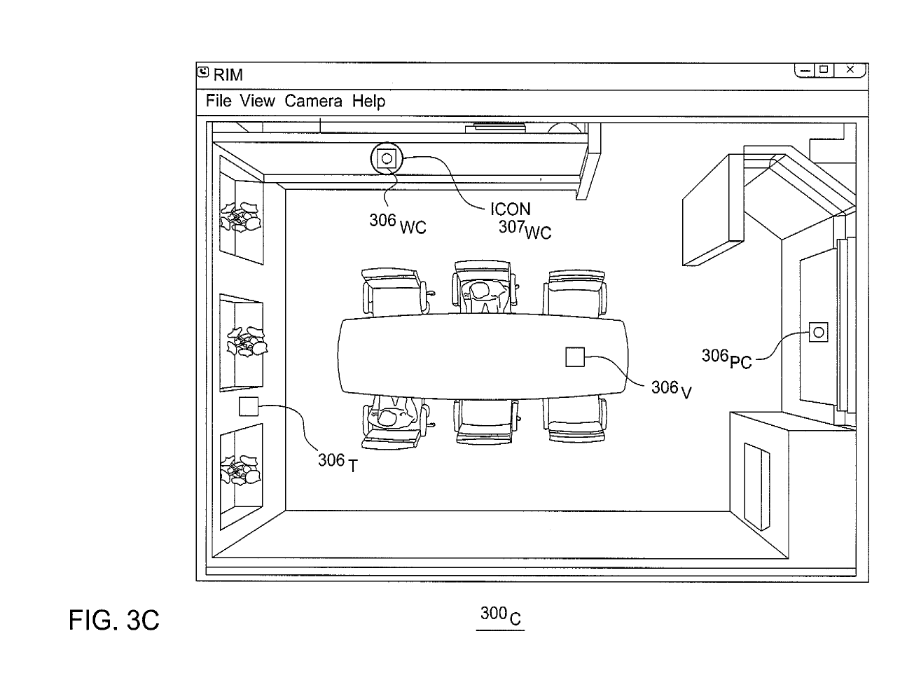

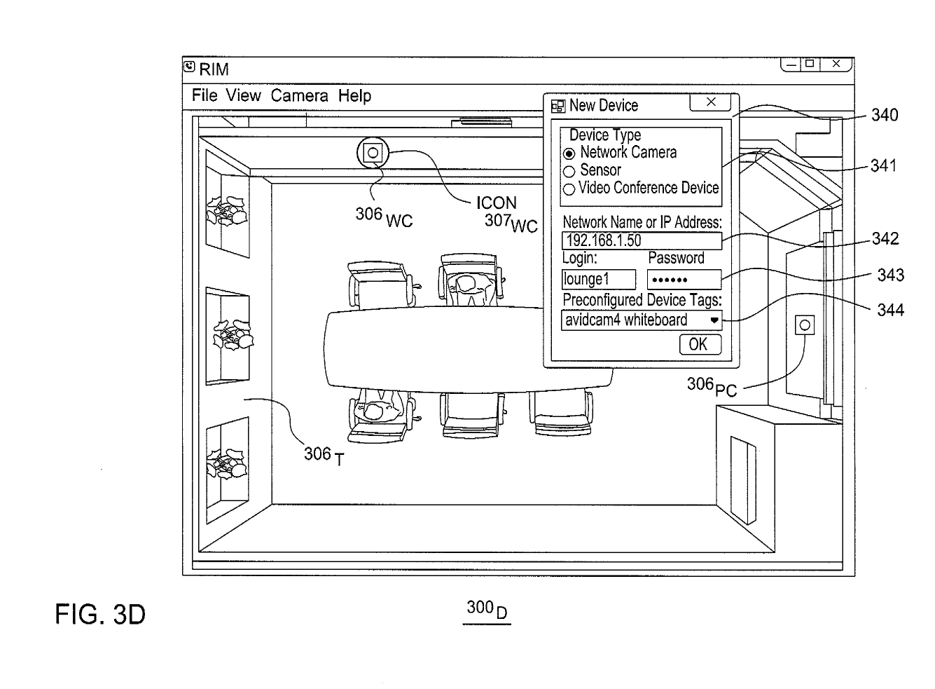

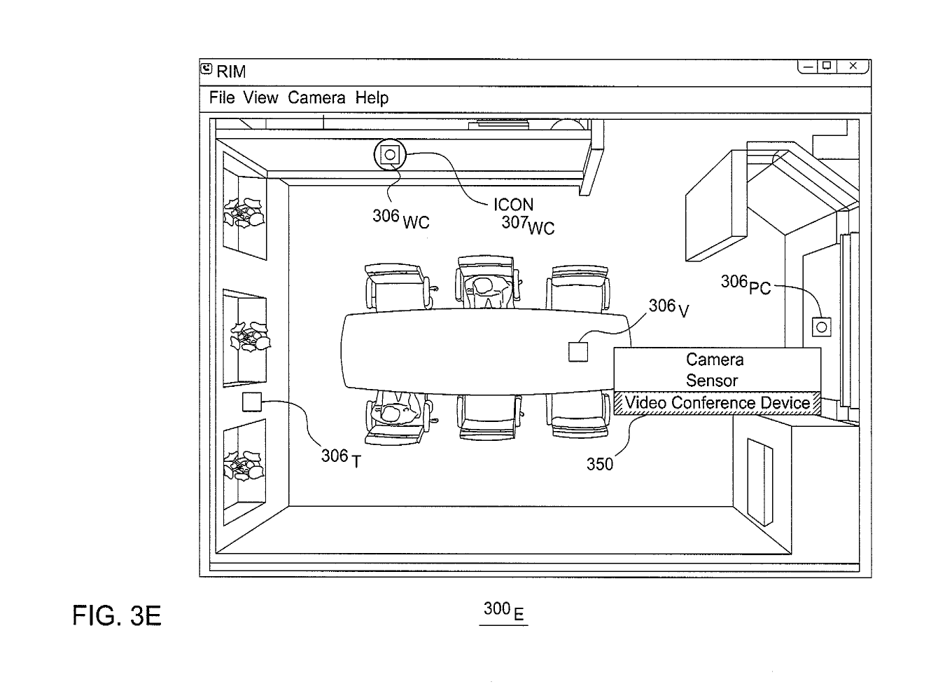

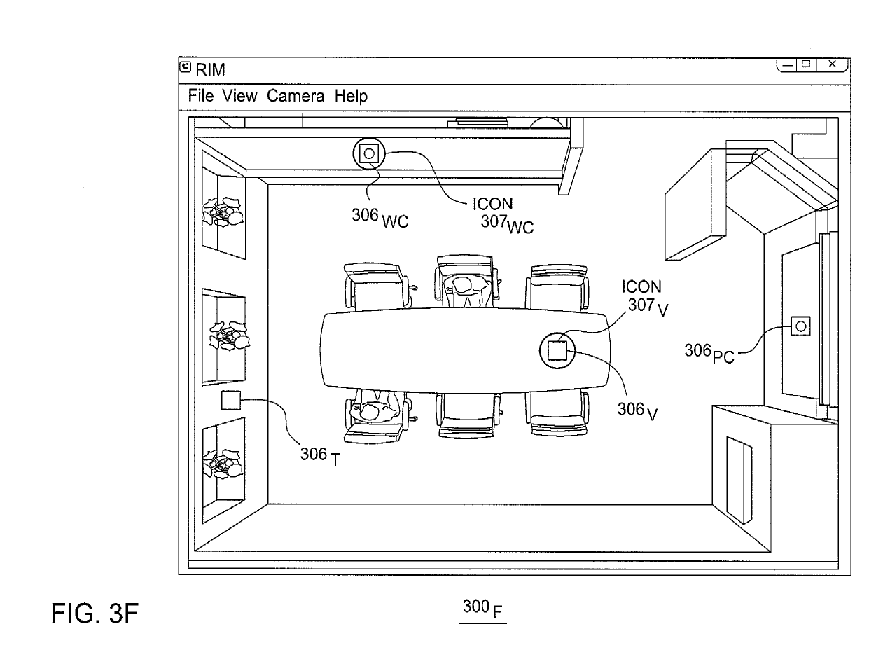

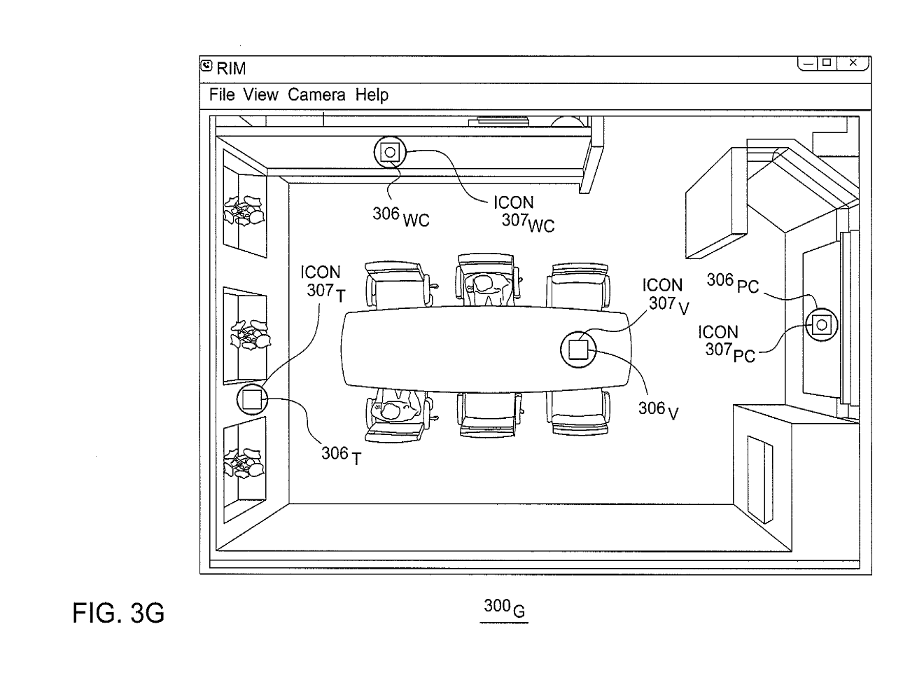

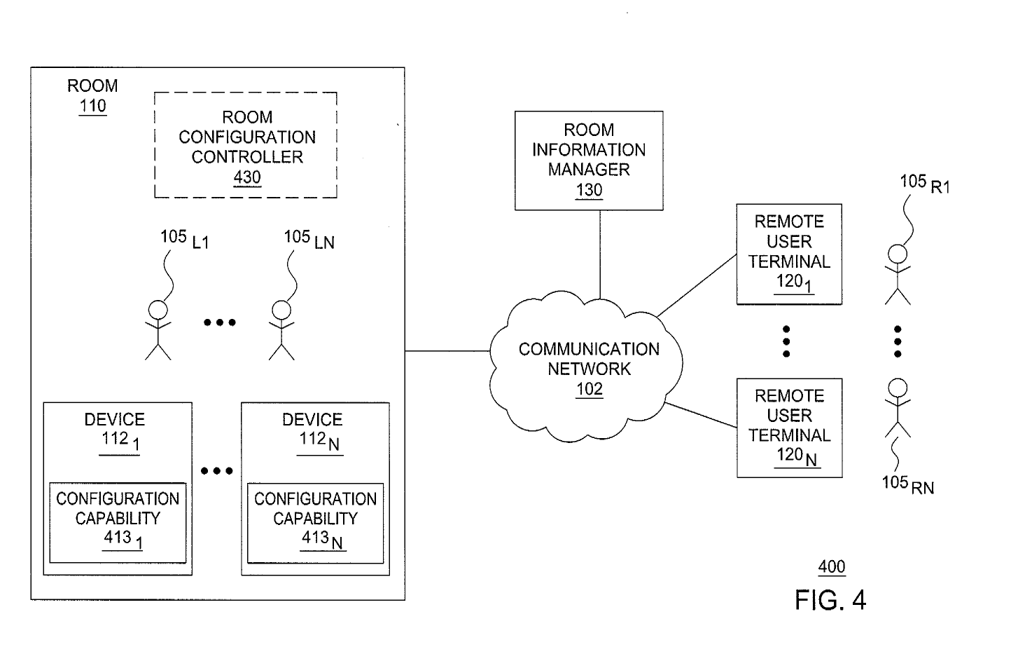

As described herein, a room configuration for a room may be created based on manual interaction by a user with a graphical representation of the room (e.g., using various capabilities depicted and described with respect to FIGS. 3A-3G) or automatically using configuration capabilities of the devices of the room (e.g., using various capabilities as depicted and described herein with respect to FIG. 4).

Although primarily depicted and described herein with respect to embodiments in which the graphical representation of the room is a two-dimensional representation of the room and the associated room configuration is a two-dimensional representation (for purposes of clarity), in various other embodiments the graphical representation of the room is a three-dimensional representation of the room and the associated room configuration is a three-dimensional representation.

FIGS. 3A-3G depict exemplary GUI screens provided by the RIM of FIG. 1, illustrating use of manual interactions by a user with a representation of a room of for creating a room configuration for the room.

As depicted in FIGS. 3A-3G, exemplary GUI screens 300_{A}-300_{G} (collectively, GUI screen 300) each display a graphical representation 301 of a room (denoted as room representation 301). In this example, the room depicted by room representation 301 is the room 110 of FIG. 1. The room representation 301 includes representations of various aspects of the room 110. In this example, the room representation 301 includes a representation 302 of a conference table located within room 110, and representations 303 of six chairs located around the conference table located within room 110. The room representation 301 also includes representations 304 of three plants sitting on shelves built into the wall of room 110. The room representation 301 also includes representations 305 of two local participants 105_{L} sitting in two of the chairs of room 110. The room representation 301 also includes representations 306 of or associated with four devices 112 located within room 110, including a representation 306_{WC} of a whiteboard camera 112_{WC} configured for providing a view of a whiteboard available in room 110, a representation 306_{PC} of a projector camera 112_{PC} configured for providing a view of a projector screen available in room 110, a representation 306_{V} of a video conferencing device 112_{N} located within room 110, and a representation 306_{T} of a thermostat 112_{T} configured for monitoring and/or controlling the temperature in room 110). The representations 306 may be referred to as device representations when representing devices 112 and, similarly, may be referred to as view representations when representing views available from devices 112.

As depicted in FIGS. 3A-3G, exemplary GUI screens 300 each are displayed within a window which may be displayed on any suitable display screen (e.g., computer monitor, smartphone display, and the like). The exemplary GUI screens 300 each support various graphical controls which the user may use to navigate to access various configuration functions. For example, exemplary GUI screens 300 each include FILE, VIEW, CAMERA, and HELP menu buttons which, when selected, result in display of respective drop-down menus from which the user may select various configuration functions and options. Similarly, for example, exemplary GUI screens 300 each may support various other controls, such as enabling display of one or more menus via right-click operations or similar operations initiated by the user. It will be appreciated that the navigation of the exemplary GUI screens 300 may be performed using any suitable user controls (e.g., a mouse and/or keyboard, touch screen capabilities, voice-based controls, movement/gesture-based controls, and the like, as well as various combinations thereof).

The exemplary GUI screens 300_{A}-300_{G} illustrate an exemplary process by which a user makes selections for creating a room configuration of room 301.

As depicted in FIG. 3A, the room representation 301 of the room 110 is displayed to the user within the exemplary GUI screen 300_{A}. The room representation 301 of the room 110 provides an overview of the room 110 from which the user may create the room configuration for room 110.

As depicted in exemplary GUI screen 300_{B} of FIG. 3B, the user right-clicks on one of the representations 306 (illustratively, whiteboard camera representation 306_{WC}) to select the type of device to be represented in the room configuration 301. The right-click operation results in display of a menu 320 of available device types which may be selected by the user for the selected device. In this example, three device types are displayed in menu 320 as follows: CAMERA, SENSOR, VIDEO CONFERENCE DEVICE. The user highlights and selects the CAMERA menu item for associating an icon with whiteboard camera representation 306_{WC}. Although primarily depicted and described with respect to specific device types available from menu 320, it will be appreciated that any other suitable device type(s) may be available from menu 320 (which may depend on one or more factors such as the types of devices located in the room, the types of devices expected to be located in the building for which room configurations are configured, and the like, as well as various combinations thereof).

As depicted in exemplary GUI screen 300_{C} of FIG. 3C, upon selection by the user of the CAMERA menu item for whiteboard camera representation 306_{WC}, an icon 307_{WC} is associated with whiteboard camera representation 306_{WC}, within the context of the room representation 301, such that the icon 307_{WC} becomes part of the room configuration stored for room 110.

As depicted in exemplary GUI screen 300_{D} of FIG. 3D, following the creation of the icon 307_{WC} associated with whiteboard camera representation 306_{WC}, the user may then configure the whiteboard camera 112_{WC} via selection of the icon 307_{WC} associated with whiteboard camera representation 306_{WC}. The user clicks icon 307_{WC} associated with whiteboard camera representation 306_{WC} in order to access a device configuration window within which the user may configure one or more parameters of the whiteboard camera 112_{WC}. This operation results in display of a device configuration window 340 providing a capability by which the user may configure the whiteboard camera 112_{WC}. In this example, device configuration window 340 includes a DEVICE TYPE selection option 341, a NETWORK NAME/IP ADDRESS entry field 342, LOGIN and PASSWORD entry fields 343, and a PRECONFIGURED DEVICE TAGS field 344. The DEVICE TYPE selection option 341 includes three radio buttons associated with device types CAMERA (pre-selected), SENSOR, and VIDEO CONFERENCE DEVICE. The NETWORK NAME/IP ADDRESS entry field 342 enables the user to enter an IP address of the whiteboard camera 112_{WC}. The LOGIN and PASSWORD fields 343 enable the user to specify login and password values for the whiteboard camera 112_{WC}. The PRECONFIGURED DEVICE TAGS field 344 enables the user to associate a device tag with whiteboard camera 112_{WC}. Although primarily depicted and described with respect to specific numbers and types of parameters available from device configuration window 340, it will be appreciated that any other suitable number(s) and/or types of parameters may be configured via device configuration window 340 (which may depend on one or more factors such as the type of device being configured, the level of configuration which the user is allowed to provide, and the like, as well as various combinations thereof).

As a result of the configuration functions performed as described in FIGS. 3B, 3C, and 3D, when the room configuration for room 110 is later accessed for use during a meeting in room 110, the icon 307_{WC} associated with whiteboard camera representation 306_{WC} is displayed for enabling remote participants 105_{R} to access and/or control whiteboard camera 112_{WC}.

As depicted in exemplary GUI screen 300_{E} of FIG. 3E, the user right-clicks on another one of the representations 306 (illustratively, video conferencing device representation 306_{V}) to select the type of device to be represented in the room configuration. The right-click operation results in display of a menu 350 of available device types which may be selected by the user for the selected device. In this example, three device types are displayed in menu 350 as follows: CAMERA, SENSOR, VIDEO CONFERENCE DEVICE. The user highlights and selects the VIDEO CONFERENCE DEVICE menu item for associating an icon with the video conferencing device representation 306_{V}.

As depicted in exemplary GUI screen 300_{F} of FIG. 3F, upon selection by the user of the VIDEO CONFERENCE DEVICE menu item for video conferencing device representation 306_{V}, an icon 307_{V} is associated with the video conferencing device representation 306_{V}, within the context of the room representation 301 of the room 110, such that the icon 307_{V} becomes part of the room configuration stored for room 110. The user may then configure video conferencing device 112_{N} by selecting the icon 307_{V} associated with the video conferencing device representation 306_{V} for accessing a device configuration window associated with video conferencing device representation 306_{V} (omitted for purposes of clarity).

As a result of the configuration functions performed as described in FIGS. 3E and 3F, when the room configuration for room 301 is later accessed for use during a meeting in room 301, the icon 307_{V} associated with video conferencing device 306_{V} is displayed for enabling remote participants 105_{R} to access and control video conferencing device 306_{V}.

As depicted in exemplary GUI screen 300_{G} of FIG. 3G, the user (1) performs similar configuration operations in order to create icons 307_{PC} and 307_{T} for projector camera representation 306_{PC} and thermostat representation 306_{T}, respectively, such that the icons 307_{PC} and 307_{T} each become part of the room configuration stored for room 110, and (2) configures projector camera 112_{PC} and thermostat 112_{T} by selecting the projector camera representation 307_{PC} and thermostat representation 307_{T} associated with projector camera 112_{PC} and thermostat 112_{T} for accessing the device configuration windows (omitted for purposes of clarity) associated with projector camera representation 306_{PC} and thermostat representation 306_{T}, respectively.

As a result of the configuration functions performed as described in FIG. 3G, when the room configuration for room 110 is later accessed for use during a meeting in room 110, icons 307_{PC} and 307_{T} associated with projector camera representation 306_{PC} and thermostat representation 306_{T} are displayed for enabling remote participants 105_{R} to access and control projector camera 112_{PC} and/or thermostat 112_{T}, respectively.

Accordingly, exemplary GUI screen 300_{G} of FIG. 3G depicts the room configuration for room 110 which is stored for later use by remote participants 105_{R} of meetings held in room 110. As illustrated in FIG. 3G, the room configuration is a graphical representation of room 110 which includes icons 307 associated with representations 306 representing devices 112 that are physically located within room 110 and/or views available from devices 112 that are physically located within room 110.

With respect to the exemplary GUI screens 300 of FIGS. 3A-3G, it will be appreciated that the design and operation of the exemplary GUI screens 300 may be modified in any suitable manner. For example, although primarily depicted and described with respect to exemplary GUI screens 300 having a particular arrangement of displayed information and available functions and capabilities, it will be appreciated that the displayed information and/or functions and capabilities depicted and described herein may be arranged within exemplary GUI screens 300 in any other suitable manner. For example, although primarily depicted and described with respect to use of buttons, menus, data entry fields, and like user interface means, it will be appreciated that any suitable user interface means may be used for navigating exemplary GUI screens 300, making selections within exemplary GUI screens 300, entering information into exemplary GUI screens 300, and performing like functions, as well as various combinations thereof.

As described herein, RIM 130 may have access to various templates which may be used for enabling creation of the room configuration for room 110. In one embodiment, for example, the templates may include room templates, device templates (e.g., for configuring devices associated with icons 307), and the like. The various templates may be stored in a local database of RIM 130, accessed by RIM 130 from a database remote from RIM 130, and the like, as well as various combinations thereof.

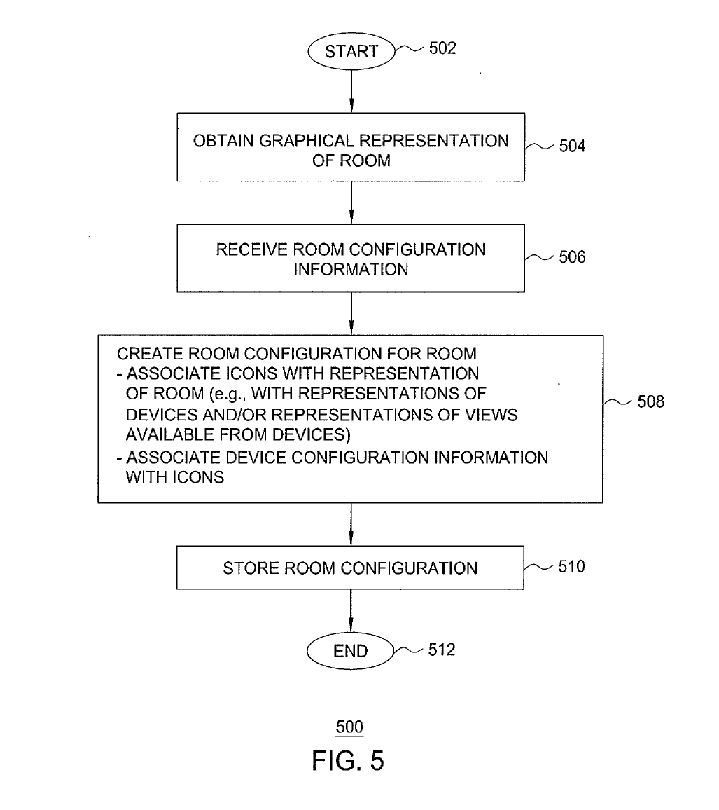

As the user makes selections via the exemplary GUI screens 300, configuration information is received at RIM 130 and processed by RIM 130 for creating the associated room configuration for room 301. An exemplary embodiment of a method which may be performed by RIM 130 for creating a room configuration, based on manual interaction by a user with a graphical representation of the room, is depicted and described with respect to FIG. 5.

FIG. 4 depicts the exemplary system of FIG. 1, illustrating use of configuration capabilities of the devices located within the room in which the meeting is being held for creating a room configuration for the room.

As depicted in FIG. 4, exemplary system 400 of FIG. 4 is substantially identical to exemplary system 100 of FIG. 1. The devices 112₁-112_{N} include a plurality of configuration capabilities 413₁-413_{N} (collectively, configuration capabilities 413). The exemplary system 400 also optionally may include a room configuration controller (RCC) 430 configured for performing various functions in support of creation of a room configuration for room 110.

The configuration capabilities 413 include any capabilities which may be used by the devices 112 such that a room configuration for room 110 may be created automatically rather than manually.

In one embodiment, for example, the configuration capabilities 413 may include communications capabilities by which the devices 112 communicate with each other, communicate with RCC 430, communicate with RIM 130, and the like, as well as various combinations thereof. In such embodiments, the local communication between devices 112 may be provided using any suitable communications capabilities (e.g., the Internet, cellular, WiFi, Bluetooth, infrared, sensors, and the like, as well as various combinations thereof). In such embodiments, communication between devices 112 and other elements (e.g., RCC 430, RIM 130, and the like) may be provided using any suitable communications capabilities (e.g., the Internet, cellular, WiFi, and the like, as well as various combinations thereof).

In one embodiment, for example, the configuration capabilities 413 may include location determination capabilities by which the locations of the devices 112 within the room 110 may be determined for purposes of determining the associated locations of the devices 112 within the representation of the room 110 which is used for creating the room configuration for room 110. For example, the devices 112 may include GPS capabilities, near-field RFID capabilities (e.g., where the devices 112 include RFID transmitters and the room 110 includes one or more associated RFID sensors which may sense the RFID transmitters to determine the locations of the devices 112, where the room 110 includes one or more associated RFID transmitters and the devices 112 include RFID sensors which may sense signals from the RFID transmitters to determine the locations of the devices 112, and the like), and the like, as well as various combinations thereof.

In one embodiment, for example, the configuration capabilities 413 may include processing capabilities by which the devices 112 may receive and process configuration information from other devices 112 (e.g., for purposes of creating a room configuration for room 110, for purposes of obtaining information which may be processed by the RCC 430 and/or the RIM 130 for creating a room configuration for room 110, and the like, as well as various combinations thereof).

The configuration capabilities 413 of devices 112 may include various other capabilities.

Although primarily depicted and described herein with respect to embodiments in which each of the devices 112 includes specific configuration capabilities 413, it will be appreciated that one or more of the devices 112 may not include any such configuration capabilities, one or more of the devices 112 may include a subset(s) of such configuration capabilities, one or more of the devices 112 may include additional configuration capabilities, and the like, as well as various combinations thereof.

In one embodiment, each of the devices 112 is configured to communicate directly with RIM 130 for purposes of providing configuration information which may be processed by RIM 130 for creating a room configuration for room 110. For example, each of the devices 112 may be configured to automatically initiate a self-registration process whereby the devices 112 register themselves with RIM 130 and provide configuration information to RIM 130, such that the RIM 130 may use the registration and/or configuration (e.g., device type of the device 112, location of the device 112 within the room 110, information which RIM 130 may use to communicate with the device 112, device configuration information, and the like, as well as various combinations thereof) to automatically create a room configuration for room 110.

In one embodiment, each of the devices 112 is configured to communicate directly with RCC 430 for purposes of providing configuration information which may be (1) processed by RCC 430 for creating a room configuration for room 110 (which may then be communicated to RIM 130 for storage at RIM 130) and/or (2) collected (and, optionally, pre-processing) by RCC 430 and provided by RCC 430 to RIM 130 which may then process the received configuration information for creating a room configuration for room 110. In this embodiment, each of the devices 112 may be configured to automatically initiate a self-registration process whereby the devices 112 register themselves with RCC 430 and/or RIM 130 in a manner similar to and/or for purposes similar to those described with respect to RIM 130.

In one embodiment, the devices 112 are configured to communicate with each other for purposes of determining location information indicative of the locations of the devices 112 within room 110 (e.g., based on one or more of near-field RFID interaction information, GPS-related information, and the like), for purposes of exchanging device configuration information, for self-registering with each other where one or more groups of devices 112 may cooperate to provide various features discussed herein, and the like, as well as various combinations thereof. In one such embodiment, one or more of the devices 112 may be configured to provide such configuration information to one or both of RCC 430 and RIM 130 for processing of the configuration information for creating a room configuration for room 110, during use of a room configuration for room 110, and the like, as well as various combinations thereof.

In one embodiment, combinations of one or more of the foregoing embodiments may be employed in combination for purposes of creating the room configuration for room 110.

Although primarily depicted and described herein with respect to an embodiment in which the RCC 430 is a standalone element located within room 110, it will be appreciated that RCC 430 may be implemented in other ways. In one embodiment, RCC 430 may be located outside of room 110 (e.g., in another room within the building, in another geographic location, and the like). In one embodiment, RCC 430 may be implemented using multiple elements which may be located within room 110 and/or outside of room 110. In one embodiment, various functions of RCC 430 may be implemented within one or more of the devices 112 (e.g., where one or more of the devices 112 are configured to operate as controllers for facilitating creation of a room configuration for room 110). In one embodiment, RCC 430 may be implemented within RIM 130. Various combinations of such embodiments, as well as other embodiments, are contemplated.

In such embodiments associated with automatic creation of the room configuration for a room, configuration information is received at RCC 430 and/or RIM 130 and processed by RCC 430 and/or RIM 130 for creating the associated room configuration for room 110. An exemplary embodiment of a method which may be performed by RCC 430 and/or RIM 130 for creating a room configuration, based on received configuration information, is depicted and described with respect to FIG. 5.

In one embodiment, a hybrid process for creating a room configuration for a room also may be used. In one such embodiment, various aspects of the manual and automatic methods for creation of a room configuration for a room may be used in conjunction to create a room configuration for a room.

FIG. 5 depicts one embodiment of a method for creating a room configuration for a room using room configuration information.

At step 502, method 500 begins.

At step 504, a graphical representation of the room is obtained. The graphical representation of the room includes graphical representations of devices located within the room.

The graphical representation of the room may be any suitable type of graphical representation. For example, the graphical representation of the room may be a CAD-based representation, an image-based representation, or any other suitable type of representation. For example, the graphical representation may be a two-dimension representation or a three-dimensional representation. The graphical representation of the room may be provided in any other suitable form.

The graphical representation of the room may be obtained in any suitable manner, which may depend on the type of graphical representation to be used. In one embodiment, the graphical representation of the room is selected from a library of room templates (e.g., based on one or more characteristics, such as the size of the room, the layout of the room, and the like). In one embodiment, the graphical representation of the room is entered by a user using a graphic design tool or any other suitable tool. In one embodiment, the graphical representation of the room is obtained by processing one or more pictures or videos of the room. In one embodiment, the graphical representation of the room may be determined by processing sensor measurements from sensors deployed within the room (e.g., determining the physical room dimensions from actual measurements taken using ultrasonic ranging sensors mounted on the walls of the room). It will be appreciated that combinations of such processes may be used. The graphical representation of the room may be obtained in any other suitable manner.

At step 506, room configuration information is received. The room configuration information may include information associated with user interactions with a graphical representation of the room and/or information received in conjunction with automatic creation of the room configuration for the room (e.g., configuration information from the devices). The types of room configuration information which may be received will be better understood by way of reference to FIGS. 3A-3G and 4.

At step 508, a room configuration for the room is created using at least a portion of the room configuration information.

The generation of the room configuration includes association of icons with representations of devices depicted within the graphical representation of the room and/or associations of icons with views available from devices depicted within the graphical representation of the room. As noted herein, the association of icons with devices and/or views may be made in response to manual selections made by a user and/or automatically.

The generation of the room configuration includes association of device configuration information for the devices with the icons associated with the graphical representation of the room (e.g., icons associated with the representations of devices and/or icons associated with the representations of the views available from the devices). The device configuration information may be obtained in any suitable manner, which may depend on the type of device. In one embodiment, device configuration information is entered by a user based on manual interaction by the user with a device configuration capability. In one embodiment, device configuration information is obtained automatically (e.g., via an automated device configuration discovery procedure or any other suitable capability). The device configuration information may be obtained in any other suitable manner.

At step 510, a room configuration for the room is stored. The room configuration comprises the graphical representation of the room including the icons and the associated device configuration information of the devices. In this manner, the room configuration is available for selection by remote participants of meetings held in the room and each of the devices associated with the room configuration may be accessed and/or controlled by remote participants of meetings held in the room.

At step 512, method 500 ends.

As described herein, and referring again to FIG. 1, at the time of the meeting, local participants 105_{L} and remote participants 105_{R} access the room 110 for purposes of participating in the meeting. The local participants 105_{L} physically arrive at the room 110 and participate in the meeting, whereas the remote participants 105_{R} access the room configuration for the room 110 in which the meeting is being held and use the room configuration to obtain a perspective of the meeting taking place in room 110.

The remote participants 105_{R} may access the room configuration for room 110 in any suitable manner. In one embodiment, for example, a remote participant 105_{R} (1) logs into a server (illustratively, RIM 130), (2) searches for the room 110 in which the meeting is to be held, and (3) upon locating the room 110 in which the meeting is to be held, initiates a request to receive the room configuration preconfigured for the room 110.

In one embodiment, various levels of security may be applied (e.g., requiring a login/password for access to the server to search for room configurations, using access control lists (ACLs) for room configurations in order to restrict access to the room configurations, and the like).

In one embodiment, prior to selecting a room, the remote participants 105_{R} may be able to review room status indicators associated with various rooms. The room status indicator for a room may be set by one of the local participants 105_{L} in the room 110. The room status indictor for a room also may be provided based on actual sensor measurements taken by sensors located within and/or near the room. The indicator may provide information such as whether or not people are present in the room, how many people are present in the room, and the like, as well as various combinations thereof. This will enable remote participants 105_{R} to view the statuses of various rooms in order to determine whether they are available or occupied. It will be appreciated that this capability also may be provided to a remote participant 105_{R} after the remote participant 105_{R} selects a room to access (e.g., updated in real time so that the remote participant 105_{R} knows the real-time status of the room).

As described herein, upon selection of a room by the remote participant 105_{R}, the room configuration is then presented to the remote participant 105_{R} in order to enable the remote participant 105_{R} to access and/or control the devices 112 physically located within room 110 in which the meeting is to be held.

The remote participant 105_{R}, using a room configuration presented to the remote participant 105_{R}, may access and/or control devices 112 represented within the room configuration via icons available from the room configuration for the room 110.

The types of access and/or control of devices 112 which may be performed by the remote participant 105_{R} via the associated icons of the room configuration may depend on the device types of the devices 112 and/or the view types of the views available from the devices 112.

For example, if the device that is accessed is a camera, the remote participant 105_{R} will receive a video stream from the camera, thereby gaining the perspective of that camera within the room 110 (e.g., of content being presented within the room 110, of local participants 105_{L} located within the room 110, and the like, as well as various combinations thereof).

In one embodiment, for example, if the device that is accessed is a video conferencing device, the remote participant 105_{R} may be provided with an option to initiate a video conferencing device video session.

In one embodiment, for example, if the device that is accessed is a projector, the remote participant 105_{R} receives a video stream carrying the presentation being shown via the projector.

In one embodiment, for example, if the device that is accessed is a sensor, the remote participant 105_{R} is able to respond to events taking place within the room 110.

In one embodiment, for example, rendering of audio of the meeting for the remote participant 105_{R} may be controlled based on control of one or more of the devices by the remote participant 105_{R}. In one embodiment, for example, in which a single video window is active for remote participant 105_{R}, the audio is proportionally rendered from the left and/or right speakers according to the location of the active video window within the GUI screen (e.g., with respect to the overall dimensions of the GUI screen). In one embodiment, for example, in which multiple video windows are active for remote participant 105_{R}, the audio is rendered from the left and/or right speakers according to the locations of the active video windows within the GUI screen such that the remote participant 105_{R} will be able to distinguish between the audio streams as originating from different directions.

In this manner, the remote participant 105_{R} is provided with a capability to access any portion of the room 110 or aspect of the meeting within the room 110 that the user thinks is important at that time, or would like to access at that time, and the like.

Thus, using such capabilities, the remote participant 105_{R} is able to become immersed within the meeting, in a manner personalized by the remote participant 105_{R}, even though the remote participant 105_{R} is located remote from the room 110 within the meeting is physically being held.

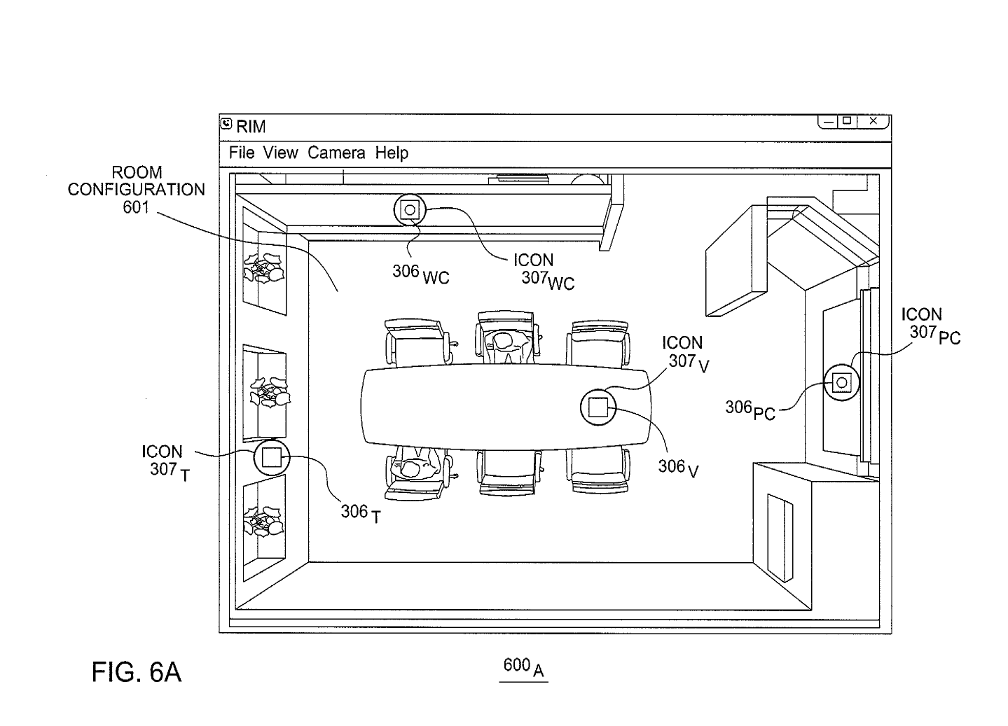

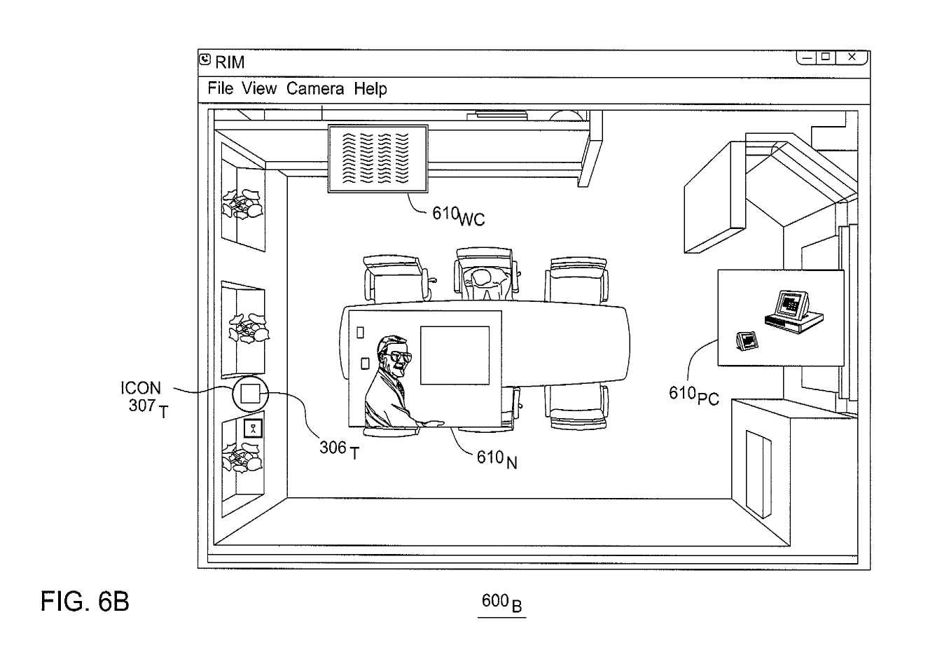

An exemplary use of a room configuration to enable a remote participant to access and control devices is depicted and described with respect to exemplary GUI screens of FIGS. 6A-6B.

FIGS. 6A-6B depict exemplary GUI screens provided by the RIM of FIG. 1, illustrating use of a room configuration by a remote participant for accessing and controlling devices physically located within the room.

As depicted in FIGS. 6A-6B, exemplary GUI screens 600_{A}-600_{B} (collectively, GUI screen 600) each display a room configuration 601 which is identical to the room configuration depicted and described with respect to FIG. 3G.

As depicted in exemplary GUI screen 600_{A}, the room configuration 601 includes: (1) the graphical representations of FIGS. 3A-3G (i.e., the room representation 301, the conference table representation 302, the chair representations 303, the local participant representations, and the like), (2) the representations 306 of devices 112, (3) the icons 307 associated with the representations 306 of devices 112 and/or representations of views available from devices 112, and (4) the device configuration information associated with the respective devices 112 (not depicted). These various elements are depicted and described with respect to one or more of the exemplary GUI screens 300_{A}-300_{G} of FIGS. 3A-3G.

In general, any of the devices 112 may be enabled by the remote participant 105_{R} via the icons 307, such that the remote participant 105_{R} may then access and control the devices 112, by simple user interactions within the context of the exemplary GUI screens 600 (e.g., by right-clicking the icons 307, by highlighting the icons 307 and selecting one or more menu options, and the like, as well as various combinations thereof).

As depicted in exemplary GUI screen 600_{B}, the remote participant 105_{R} has activated three devices 112 via the associated icons 307 of the room configuration 601. The remote participant 105_{R} has activated the whiteboard camera 112_{WC} via its associated whiteboard camera icon 307_{WC}, resulting in display of a whiteboard camera window 610_{WC} which is displaying a video stream of content on an associated whiteboard located within the room 110. The remote participant 105_{R} also has activated the video conferencing device 112_{N} via its associated video conferencing device icon 307_{V}, resulting in display of a video conferencing device window 610_{N} which is displaying a video stream showing one of the local participants 105_{L} located within the room 110. The remote participant 105_{R} also has activated the projector camera 112_{PC} via its associated projector camera icon 307_{PC}, resulting in display of a projector camera window 610_{PC} which is displaying a video stream showing content presented via a projector located within the room 110. As a result, the remote participant 105_{R} is able to experience and interact within the context of the meeting as if actually physically present within the room 110.

Although primarily depicted and described with respect to basic capabilities which may be provided using individual devices such as cameras and video conferencing devices (for purposes of clarity), it is contemplated that various other capabilities may be used for providing a more immersive meeting experience for remote participants.

In one embodiment, for example, the remote user terminals may also include an indicator of the room status which is provided as a result of actual sensor measurements. For example, the remote participant 105_{R} may view the statuses of various rooms to see if they are occupied or available. An example of room status may be whether there are people present in the room or how many people are in the room.

In one embodiment, for example, the locations of the devices 112 within the room 110 may be tracked in real-time and changes in the locations of the devices 112 within the room 110 may be reflected in the room configuration of room 110 that is provided to remote participants 105_{R}. The tracking of the locations of the devices 112 may be provided in any suitable manner, such as by using indoor location tracking capabilities available within the devices 112, using sensors or scanners deployed within the room 110 for this purpose, and the like, as well as various combinations thereof. In this manner, the remote participants 105_{R} are able to see the locations of the devices 112 in real-time, such that the remote participants 105_{R} have a better understanding of the perspective of room 110 that will be experienced when the associated devices 112 are accessed by the remote participants 105_{R}.

In one embodiment, for example, one or more sensors or scanners may be positioned within the room 110 for tracking the movement of the local participants 105_{L} present within the room 110. The movements of the local participants 105_{L} may then be reflected within the room configuration of room 110 in real-time such that the remote participants 105_{R} are able to see the movement of the local participants 105_{L} present within the room 110. The local participants 105_{L} may be represented within the room configuration in any suitable manner (e.g., using avatars, icons, and the like).

In one embodiment, for example, a device-like icon may be associated with one or more of the local participants 105_{L} such that a remote participant 105_{R} may activate the icon associated with a local participant 105_{L} for enabling the remote participant 105_{R} to gain the perspective of that local participant 105_{L} (e.g., a video feed of the perspective of that local participant 1050 and/or to interact with that local participant 105_{L} (e.g., a video chat session between the remote participant 105_{R} and that local participant 105_{L}). In one such embodiment, one or more sensors may be positioned within the room for tracking the bodily movements of the local participants 105_{L} (e.g., head turns, gestures, and the like), thereby enabling automation of changing of the perspective of the local participant 105_{L} that is experienced by the remote participant 105_{R} (e.g., when the local participant 105_{L} turns his or her head or points in a certain direction, the view of the room 110 that is provided to the remote participant 105_{R} via the associated room configuration changes automatically).

In one embodiment, for example, multiple cameras may be positioned within room 110 for providing a three-dimensional (3D) representation of the room. In one embodiment, the room configuration of the room 110 may be created from the 3D representation of the room 110. In one embodiment, the room configuration of the room 110 may be based upon a 2D representation of the room which may include an icon that is associated with the group of cameras, such that the icon associated with the group of cameras provides the remote participants 105_{R} with an option to access the 3D representation of the room 110 (e.g., similar to the manner in which the remote participants 105_{R} may access and/or control other devices within the room 110). In at least some such embodiments, the remote participants 105_{R} may be provided a capability to interact with the 3D representation of the room 110 (e.g., to view the room 110 from any angle, to zoom in and out, adjusting the level of the view (e.g., to eye level, to look up, to look down, and the like), and the like, as well as various combinations thereof).

In one embodiment, a remote participant 105_{R} may be able to access and/or control the room configuration of the room 110 using one or more controls in addition to and/or in place of the GUI-type controls primarily depicted and described herein.

In one embodiment, for example, a remote participant 105_{R} may use voice-based command for accessing and/or controlling various functions available from RIM 130 (e.g., where the remote user terminal 120 and RIM 130 support use of voice-based controls within this context). These types of controls may be used for accessing a room configuration, accessing devices, controlling devices, accessing views, controlling views, and the like,

In one embodiment, for example, a remote participant 105_{R} may use voice-based command for accessing and/or controlling various functions available from RIM 130 (e.g., where the remote user terminal 120 and RIM 130 support use of voice-based controls within this context). These types of controls may be used for accessing a room configuration, accessing devices, controlling devices, accessing views, controlling views, and the like, For example, the remote participant 105_{R} may change his or her view of the room 110 by simply turning his or her head, may access and/or control a device 112 within room 110 via simple movements of the hand, and the like.

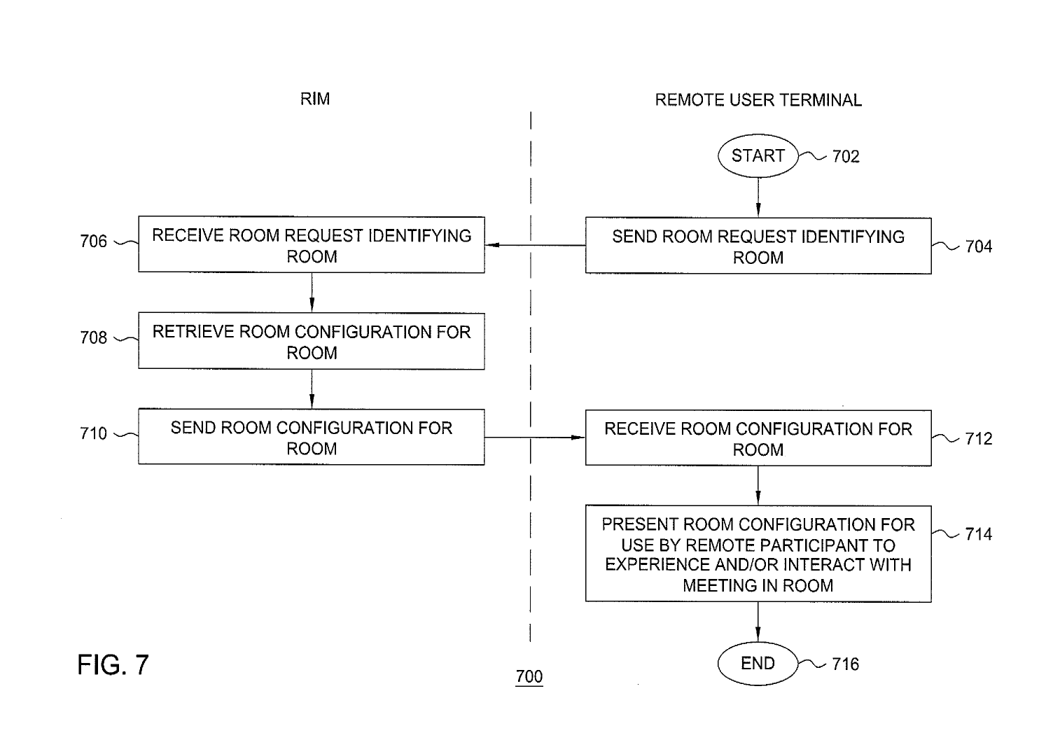

It will be appreciated that other types of user controls may be utilized by remote participants 105_{R} for accessing and/or controlling various functions available from RIM 130. FIG. 7 depicts one embodiment of a method for using a room configuration of a room for accessing and controlling one or more devices physically located within the room. As depicted in FIG. 7, some of the steps are performed by a RIM and some of the steps are performed by a remote user terminal of a remote participant.

At step 702, method 700 begins.

At step 704, the remote user terminal sends a room request identifying the room.

At step 706, the RIM receives the room request identifying the room from the remote user terminal.

At step 708, the RIM retrieves a room configuration for the room. At step 710, the RIM propagates the room configuration toward the remote user terminal of the remote participant.

At step 712, the remote user terminal receives the room configuration for the room from the RIM.

At step 714, the remote user terminal presents the room configuration for use by the remote participant in experiencing and/or interacting with a meeting being held within the room.

At step 716, method 700 ends.

Although primarily depicted and described herein with respect to association of an icon with device located in a room, in other embodiments an icon may be associated with a view associated with a room. In such embodiments, the view may be a view available from a device located within the room 110 (e.g., a view of a whiteboard available from a camera located within the room 110, a view of a podium available from a camera located within the room 110, and the like), a view available from a combination of multiple devices located within the room 110, a view associated with the room 110 that is independent of any particular device located within the room 110, and the like, as well as various combinations thereof. In such embodiments, representations 306 may be considered to be representations of views available from the devices 112, respectively (which also may be referred to herein as view representations 306).

For example, in the exemplary GUI screens of FIGS. 3A-3G, the icon 307_{WC} is associated with a whiteboard camera 306_{WC} configured to provide a view of a whiteboard located within the room 110 (i.e., the icon 307_{WC} is associated with a device). However, rather than associating the icon 307_{WC} with the whiteboard camera 306_{WC}, an icon may be associated with the actual whiteboard. In this sense, since the view of the whiteboard may be provided by any suitable device or devices, the icon associated with the whiteboard may be considered to be an icon associated with a view rather than an icon associated with a device. Additionally, it will be appreciated that the device(s) that is providing the view of the whiteboard may be transparent at least to the remote participants 105_{R} (i.e., the remote participants 105_{R} want to be able to click on the icon associated with the whiteboard in order to be presented with a view of that whiteboard, and do not care how the view of that whiteboard is being provided (e.g., using a camera facing the whiteboard, using some image capture capability built into the whiteboard, and the like)).

Similarly, for example, although not depicted in the exemplary GUI screens of FIGS. 3A-3G, an icon may be associated with a location or area within the room 110, thereby indicating that the icon is associated with a view of that location or area of the room 110. In this sense, since the view of the location or area of the room 110 may be provided by any suitable device or devices, the icon may be considered to be an icon associated with a view rather than an icon associated with a device. Additionally, it will be appreciated that the device(s) that is providing the view of the location or area within the room 110 may be transparent at least to the remote participants 105_{R} (i.e., the remote participants 105_{R} want to be able to click on the icon associated with the location or area within the room 110 in order to be presented with a view of that location or area within room 110, and do not care how the view of that location or area within room 110 is being provided).

Similarly, for example, although not depicted in the exemplary GUI screens of FIGS. 3A-3G, an icon may be associated with a document located within the room 110, thereby indicating that the icon is associated with a view of that document. In this sense, since the view of the document may be provided by any suitable device or devices, the icon may be considered to be an icon associated with a view rather than an icon associated with a device. Additionally, it will be appreciated that the device(s) that is providing the view of the document may be transparent at least to the remote participants 105_{R} (i.e., the remote participants 105_{R} want to be able to click on the icon associated with the document in order to be presented with a view of that document, and do not care how the view of that document is being provided).

It will be appreciated that the foregoing examples are merely exemplary, and that icons may be associated with various other types of views, and that icons may be associated with views in various other ways.

Although primarily depicted and described herein with respect to embodiments in which a meeting has a single location in which participants meet, it will be appreciated that meetings may be held in multiple locations and, thus, that the immersive meeting capability may be used to provide various other capabilities.

In one embodiment, for example, the immersive meeting capability may be used by a remote participant to control devices in multiple meeting locations. For example, where a distributed meeting is taking place between participants located at an office in New York and participants located at an office in Los Angeles, and a remote participant accesses the meeting via a remote location, the remote participant may use the immersive meeting capability for accessing and/or controlling devices located in the meeting area in the New York office and/or devices located in the meeting area in the Los Angeles office.

In one embodiment, for example, in which a meeting is being held at multiple locations and each location has one or more participants located thereat, the immersive meeting capability may be used by one or more local participants at a first meeting location to access and/or control one or more devices at a second meeting location and vice versa. For example, where a distributed meeting is taking place between participants located at an office in New York and participants located at an office in Los Angeles, one or more of the participants in the meeting area in the New York office may use the immersive meeting capability for accessing and/or controlling devices located in the meeting area in the Los Angeles office and, similarly, one or more of the participants in the meeting area in the Los Angeles office may use the immersive meeting capability for accessing and/or controlling devices located in the meeting area in the New York office.

In this sense, the immersive meeting capability enables multiple collaborative spaces to be linked together in real-time in order to form a single collaborative area.

As described herein, although primarily depicted and described herein within the context of using the immersive meeting capability in rooms such as standard conference rooms, the immersive meeting capability may be used in other types of rooms, including in an immersive room.

In general, an immersive room is a room configured with one or more content devices and a number of sensors.

The content devices of an immersive room may include any devices which may be used to capture and/or present content. For example, the captured content may be captured such that the content may be provided to other remote locations for presentation to remote participants remote from the immersive room. For example, the presented content may be presented to local participants located within the immersive room and provided to other remote locations for presentation to remote participants remote from the immersive room. For example, the content devices may include devices such as microphones, video cameras, projectors, digital whiteboards, touch-sensitive devices (e.g., tablets, screens built into tables and other furniture, and the like), and the like, as well as various combinations thereof.

The content devices of an immersive room may be arranged in any configuration suitable for providing various functions for which the content devices are deployed and used. For example, content devices may be deployed so as to enable the remote participants to view the immersive room from virtually any perspective (e.g., by employing multiple cameras to capture all areas of the room from various perspectives). For example, content devices may be employed so as to enable the remote participants to hear audio from any part of the room and/or to speak to any part of the room (e.g., by employing a number of microphones and/or speakers throughout the immersive room).

The sensors of an immersive room may include any sensors which may be used to provide a more immersive meeting experience for remote participants remote from the immersive room. For example, sensors may include motion sensors, infrared sensors, temperature sensors, pressure sensors, ultrasound sensors, accelerometers, and the like, as well as various combinations thereof. In one embodiment, audio and/or video information available within the immersive room may be used as a type of virtual sensor for providing various associated capabilities.

The sensors of an immersive room may be arranged in any configuration suitable for providing various functions for which the sensors are deployed and used. In one embodiment, for example, certain types of sensors may be aligned within the room such that they provide a fine grid that “blankets” the immersive room. In one embodiment, for example, the sensors are configured as a network of sensors. The number of sensors deployed in the immersive room may depend on one or more factors, such as the size of the room, the layout of the room, the purpose for which the room is expected to be used, and the like, as well as various combinations thereof.

In one embodiment, an immersive room also includes significant local computing power. The computing power may include one or more computers, and, optionally, may include a group or bank of computers cooperating to provide various functions. The processing power may be used for providing various functions, such as for processing the information associated with the various content devices and sensors deployed within the immersive room, for supporting seamless networking between the immersive room and one or more other immersive rooms (which may be local and/or remote from each other), and the like, as well as various combinations thereof. This provides a streamlined capability by which the immersive rooms may be networked together, thereby enabling such a tight level of integration that the networked immersive rooms may even be represented as a single immersive room (e.g., using a single room configuration).

These and various other embodiments of immersive rooms may be better understood by considering the exemplary immersive room of FIG. 8.

FIG. 8 depicts one embodiment of an immersive room suitable for use as the room depicted and described with respect to FIG. 1.

As depicted in FIG. 8, the immersive room 800 is similar in layout to the room 301 depicted and described herein with respect to FIGS. 3A-3G.

The immersive room 800 includes an entry point 801, a conference table 802, chairs 803, windows 804, and a plurality of devices/areas 806. The devices/areas 806 include a pair of video conferencing devices (VCDs) 806_{VC1} and 806_{VC2} located on conference table 802, a whiteboard/side projection area 806_{WSP} on a first wall of immersive room 800, a dropdown projection screen 806_{DPS} on a second wall of immersive room 800, a television monitor 806_{TM} on a third wall of immersive room 800, and a work shelf/collaborative wall area 806_{WCA} (illustratively, having two personal computers (PCs) associated therewith) on a fourth wall of immersive room 800. These devices/areas 806 are used to provide an immersive meeting experience to remote participants. The immersive room 800 also includes an array of support devices 807, where the support devices 807 include devices such as video cameras, microphones and/or microphone arrays, speakers and/or speaker arrays, temperature sensors, and ultrasound sensors. As depicted in the legend of FIG. 8, the support devices 807 are identified according to device type as follows: video cameras are identified using the designation Vn, microphones and/or microphone arrays are identified using the designation MAn, speakers and/or speaker arrays are identified using the designation SPn, temperature sensors are identified using the designation Tn, and ultrasound sensors are identified using the designation USn. In each of these cases, the “n” of the designator refers to the number of that associated support device 807. The locations of the support devices 807 within immersive room 800 are indicated by the associated arrows depicted in FIG. 8. Although primarily depicted and described with respect to an exemplary immersive room having specific types, numbers, and arrangements of support devices 807, it will be appreciated that an immersive room may utilize various other types, numbers, and/or arrangements of support devices 807.

It will be appreciated that the principles of immersive rooms may be applied for providing various types of telepresence environments, such as lounges, conference rooms (e.g., as depicted and described with respect to FIG. 8), and the like. Descriptions of embodiments of lounges and conference rooms, when configured as immersive rooms, follow.

In one embodiment, for example, an immersive room may be implemented as a lounge. For example, a lounge configured as an immersive room may be a multimedia room in which one or more workers (e.g., as individuals and/or in groups) are able to spend time in a casual manner (e.g., as would occur in a café or coffee shop). The lounge may support a large network of electronic sensors, such as ultrasound sensors, temperature sensors, pressure sensors, and the like, as well as various combinations thereof. The various immersive room capabilities provided in the lounge ensure an enriching experience for those in the lounge.

In one embodiment, a lounge may include several telepresence clients installed in the same small physical space. The telepresence clients may be configured for performing in various types of environments, including a chaotic environment (as may be likely in a lounge implementation) which may include large amounts of ambient noise, multiple simultaneous audio and/or video calls unrelated to each other, ad hoc leave/join behaviors of participants relative to audio and/or video calls, variable numbers of participants per call, disorganized arrangements of participants within the room, ad hoc movements of participants within the room, and the like, as well as various combinations thereof.

In one embodiment, a lounge may include a variety of electronic sensors which may be configured for performing functions such as determining the locations of people within the room, determining the groupings of people within the room, determining the focus of people within the room, determining the activities of people within the room, and the like, as well as various combinations thereof. In one embodiment, the types, numbers and/or locations of sensors within the lounge may be refined over time. The aggregation and post-processing of sensor data for performing such functions may be referred to herein as sensor fusion.

In one embodiment, sensor-derived information may be used for orchestrating activities within the room, as well as for allowing orchestration of activities over multiple locations (e.g., via communication of the sensor-derived information to one or more other locations and receipt of sensor-derived information from one or more other locations).

In one embodiment, a “matter-transport” feature may be supported, whereby an object may be scanned from multiple angles, the scanned data is post-processed, the post-processed scanned data is transmitted to a remote location, and, at the remote location, the scanned object is reconstructed for display at the remote location. This operation may be described as “beaming” of the object from a first location to a second location.

As with other types of immersive rooms, the lounge will enhance the capabilities of meeting participants and will facilitate collaboration between local and remote meeting participants.

In one embodiment, for example, an immersive room may be implemented as a conference room (e.g., such as immersive room 800 depicted and described with respect to FIG. 8). For example, a conference room configured as an immersive room may be a typical conference room in which multiple people sit in statically-positioned seats in a large room, engaging in fairly formal communication with one or more similar rooms at one or more other locations, or perhaps with various endpoints of various types, which are geographically dispersed. While the conference room may be less chaotic than the lounge, it may present greater challenges in certain areas, such as high speed audio and video communication, collaboration, multipoint, intelligent capture of large groups of participants, and the like. In one embodiment, as opposed to embodiments of the lounge, the conference room may have a limited number of electronic sensors but a large number of video cameras deployed throughout the conference room, thereby enabling derivation of state information using video analytics.

In one embodiment, a conference room may include several telepresence clients. The telepresence clients may be configured for performing in various types of environments and under various conditions, such as where there are multiple potentially interfering telepresence clients, where there are ad-hoc and small-group meetings centered around different telepresence equipment, and the like.

In one embodiment, as with a lounge, a conference room may include a variety of electronic sensors which may be configured for performing functions such as determining the locations of people within the room, determining the focus of people within the room, determining the activities of people within the room, and the like, as well as various combinations thereof. In one embodiment, the types, numbers and/or locations of sensors within the lounge may be refined over time. The sensors may include video cameras, audio capture devices, environmental sensors (e.g., temperature, pressure, and the like), and the like, as well as various combinations thereof. In one embodiment, video is used as a primary sensor, thereby resulting in richer fusion input and greatly expanding the possibilities for future growth.

In one embodiment, sensor fusion (e.g., from the aggregation and post-processing of sensor data) may be used for performing various functions. In one embodiment, for example, multiple video cameras may be used to provide one or more of motion detection, gesture recognition, facial recognition, facial archival, primary audio/video source selection, and the like, as well as various combinations thereof. In one embodiment, for example, multiple microphone arrays (which may include personal and/or group-targeted elements) may be used to provide audio detection, audio recognition, audio source identification, and the like, as well as various combinations thereof. In one embodiment, for example, electronically steerable ambisonic multi-element microphones may be used. In one embodiment, personal room lighting with automatic controls may be used.

In one embodiment, as described herein, the conference room may include various devices and capabilities which facilitate dynamic meeting participation at multiple sites, such as enhanced audio conferencing, spatial audio rendering, video conferencing, document transfers, beaming, and the like, as well as various combinations thereof.

In one embodiment, the configuration of an immersive room may be modified based on one or more of processing of sensor data from sensors deployed within the immersive room, subjective feedback information from participants who use the immersive room (e.g., whether physically present in the immersive room or interacting with the immersive room remotely), and the like, as well as various combinations thereof.

As described herein, the immersive meeting capability provides various advantages, including enhanced productivity during meetings, more engaged employees, time savings, a decrease in business overhead costs resulting from an increase in the use of remote offices and equipment and elimination of business trips between locations as the remote access becomes more engaging, achievement of better collaboration and tighter organization linkage across time zones for multi-national corporations, facilitation of the ability to host meeting guests externally without the security concerns often associated with having in-person visitors on site, and the like, as well as various combinations thereof.

Although primarily depicted and described herein with respect to use of icons for providing access to and/or control of devices and/or views available from devices, it will be appreciated that any other suitable mechanisms (e.g., widgets, tabs, and the like), in addition to or in place of icons, may be used for providing access to and/or control of devices and/or views available from devices.

Although primarily depicted and described herein within the context of use of the immersive meeting capability in a specific type of environment (i.e., for collaborative meetings), the various functions of the immersive meeting capability may be adapted for use in various other environments.

In one embodiment, for example, the immersive meeting capability may be adapted for use in providing remote home monitoring. For example, it may be used to provide remote monitoring of a primary residence when at work, on vacation, or any other time away from the primary residence. For example, it may be used to provide remote monitoring of a secondary residence (e.g., vacation home). Various other remote home monitoring embodiments are contemplated.

In one embodiment, for example, the immersive meeting capability may be adapted for use in providing remote monitoring of and interaction with individuals. For example, it may be used to provide remote monitoring of children being watched by babysitters, child care institutions, and the like. For example, it may be used to provide remote monitoring of the elderly in eldercare situations. In such cases, this may include capabilities via which the remote person is able to gain various views of the location in which the individual is being watched, talk to the individual and/or the person(s) responsible for caring for the individual via an audio connection, talk to the individual and/or the person(s) responsible for caring for the individual via a video connection, access various sensors for determining and/or controlling various conditions at the location in which the individual is being cared for (e.g., temperature, lighting, and the like), and the like, as well as various combinations thereof. Various other remote individual monitoring and interaction embodiments are contemplated.

In one embodiment, for example, the immersive meeting capability may be adapted for use in providing remote monitoring of locations and interaction with individuals at the locations (e.g., locations such as stores, warehouses, factories, and the like).

For example, it may be used to provide remote monitoring of stores, warehouses, factories, and various other locations for security purposes.

For example, it may be used to provide improved customer service at stores, whereby remote users are able to help customers located at the stores. For example, where a remote user sees that a customer seems to be having trouble locating an item within the store, the remote user may initiate an audio connection or video connection with the customer in order to tell the customer where the item may be located within the store. For example, where a remote user determines that a customer has questions, the remote user may initiate an audio connection or video connection with the customer in order to answer any questions for the customer.

Various other remote location monitoring and interaction capabilities are contemplated.

As such, when adapted for use in other types of environments, the immersive meeting capability also may be referred to more generally as an improved remote monitoring and interaction capability.

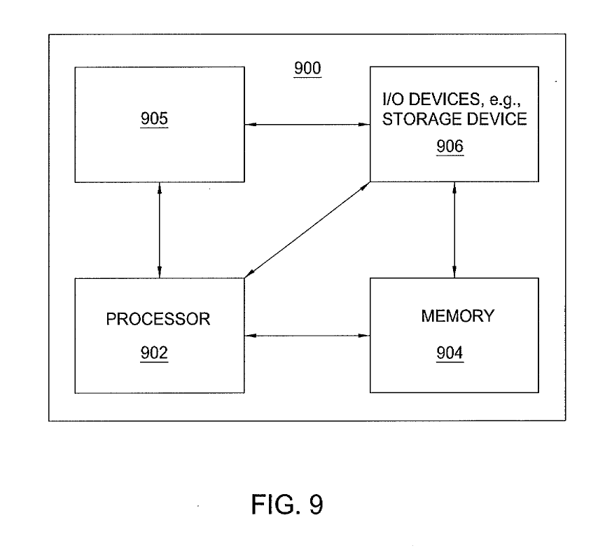

FIG. 9 depicts a high-level block diagram of a computer suitable for use in performing functions described herein.

As depicted in FIG. 9, computer 900 includes a processor element 902 (e.g., a central processing unit (CPU) and/or other suitable processor(s)), a memory 904 (e.g., random access memory (RAM), read only memory (ROM), and the like), a cooperating module/process 905, and various input/output devices 906 (e.g., a user input device (such as a keyboard, a keypad, a mouse, and the like), a user output device (such as a display, a speaker, and the like), an input port, an output port, a receiver, a transmitter, and storage devices (e.g., a tape drive, a floppy drive, a hard disk drive, a compact disk drive, and the like)).

It will be appreciated that the functions depicted and described herein may be implemented in software and/or hardware, e.g., using a general purpose computer, one or more application specific integrated circuits (ASIC), and/or any other hardware equivalents. In one embodiment, the cooperating process 905 can be loaded into memory 904 and executed by processor 902 to implement the functions as discussed herein. Thus, cooperating process 905 (including associated data structures) can be stored on a computer readable storage medium, e.g., RAM memory, magnetic or optical drive or diskette, and the like.

It will be appreciated that computer 900 depicted in FIG. 9 provides a general architecture and functionality suitable for implementing functional elements described herein and/or portions of functional elements described herein. For example, the computer 900 provides a general architecture and functionality suitable for implementing one or more of devices 112, remote user terminals 120, RIM 130, RCC 430, and the like.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. An apparatus, comprising:
a processor and a memory configured to:
present, at a user device, a representation of a physical area configured for use in hosting a meeting, wherein the physical area includes a device configured for being accessed remotely, wherein the representation of the physical area includes a representation of the device or a representation of a view available from the device;
detect, at the user device, selection of an icon associated with the representation of the device or the representation of a view available from the device; and
propagate, from the user device, a message configured for requesting access to the device or the view available from the device.

2. The apparatus of claim 1, wherein the message is propagated toward at least one of the device and a management system associated with the device.

3. The apparatus of claim 1, wherein the processor is configured to:
receive content from the device; and
initiate presentation of the received content.

4. The apparatus of claim 1, wherein the processor is configured to:
receive information indicative of a change to the representation of the physical area presented at the user device; and
modify the representation of the physical area presented at the user device based on the information indicative of the change to the representation of the physical area presented at the user device.

5. The apparatus of claim 4, wherein the information indicative of a change to the representation of the physical area presented at the user device comprises at least one of:
information indicative of a movement of the device within the physical area; and
information indicative of a movement of a local participant in the meeting; and
information indicative of a change in a source of content at the physical area.

6. The apparatus of claim 1, wherein the processor is configured to:
propagate, from the user device, a message configured for controlling the device or the view available from the device.

7. The apparatus of claim 1, wherein the device comprises at least one of a camera, a projector, a digital whiteboard, an audio conferencing device, a video conferencing device, and a sensor.

8. The apparatus of claim 1, wherein the memory is configured to store the representation of the physical area for presentation of the representation of the physical area at the user device.

9. The apparatus of claim 1, further comprising:
a display screen configured to display the representation of the physical area.

10. A method, comprising:
using a processor for:
presenting, at a user device, a representation of a physical area configured for use in hosting a meeting, wherein the physical area includes a device configured for being accessed remotely, wherein the representation of the physical area includes a representation of the device or a representation of a view available from the device;
detecting, at the user device, selection of an icon associated with the representation of the device or the representation of a view available from the device; and
propagating, from the user device, a message configured for requesting access to the device or view associated with the icon.

11. An apparatus, comprising:
a processor and a memory configured to:
obtain a representation of a physical area configured for use in hosting a meeting, wherein the physical area includes a device configured for being accessed remotely;
create an area configuration for the physical area, wherein creating the area configuration comprises associating an icon with a representation of the device or a representation of a view available from the device; and
propagate the area configuration toward a user device of a remote participant of a meeting held in the physical area.

12. The apparatus of claim 11, wherein associating an icon with a representation of the device comprises:
automatically determining a location of the device within the representation of the physical area; and
automatically associating the icon with the location of the device within the representation of the physical area.

13. The apparatus of claim 11, wherein associating an icon with a representation of a view available from the device comprises:
automatically determining a location of the view available from the device within the representation of the physical area; and
automatically associating the icon with the location of the view available from the device within the representation of the physical area.

14. The apparatus of claim 11, wherein creating the area configuration further comprises:
receiving device configuration information associated with configuration of the device; and
associating the device configuration information with the icon associated with the device.

15. The apparatus of claim 11, wherein creating the area configuration further comprises:
identifying a location of a local participant of the meeting within the physical area; and
associating an icon with the local participant of the meeting within the representation of the physical area.

16. The apparatus of claim 11, wherein the processor is further configured to:
receive information indicative of a change associated with the physical area; and
update the area configuration to reflect the change associated with the physical area.

17. The apparatus of claim 16, wherein the change associated with the physical area comprises at least one of:
a change of location of the device at the physical area; and
a movement of a local participant of the meeting within the physical area.

18. The apparatus of claim 11, wherein the processor is further configured to:
receive, from a user device remote from the physical area, a request for the area configuration; and
propagate the area configuration toward the user device.

19. The apparatus of claim 11, wherein the processor is further configured for:
receiving, from a user device remote from the physical area, a request to access the device, wherein the request to access the device is initiated using the area configuration; and
propagating, toward the device, the request received from the user device.

20. A method, comprising:
using a processor for:
obtaining a representation of a physical area configured for use in hosting a meeting, wherein the physical area includes a device configured for being accessed remotely;
creating an area configuration for the physical area, wherein creating the area configuration comprises associating an icon with a representation of the device or a representation of a view available from the device; and
propagating the area configuration toward a user device of a remote participant of a meeting held in the physical area.
